(19) United States
(12) Patent Application Publication
(10) Pub. No.: US 2024/0146662 A1
(43) Pub. Date: May 2, 2024

(54) SIGNAL PROCESSING EQUIPMENT, SIGNAL PROCESSING METHODS, SIGNAL PROCESSING PROGRAMS, AND SATELLITE COMMUNICATION SYSTEMS

(71) Applicant: NIPPON TELEGRAPH AND TELEPHONE CORPORATION, Tokyo (JP)

(72) Inventors: Mitsuru NISHINO, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/280,944

(22) PCT Filed: Mar. 25, 2021
(86) PCT No.: PCT/JP2021/012485

§ 371 Date: Sep. 8, 2023

(51) Int. Cl. H04L 47/2475

(52) U.S. Cl. CPC H04L 47/2475

(57) ABSTRACT

A signal processing device according to an embodiment distributes input high priority frames and low priority frames according to priorities, processes and transfers each of the distributed high priority frames and low priority frames, an accumulation unit accumulates the transferred high priority frames and low priority frames, sequentially reads out and outputs each of the high priority frames and low priority frames accumulated by the accumulation unit according to the priority, sets the low priority frames to be divided by a predetermined size and transferred in a case where the high priority frames are input or in a case where the accumulation unit accumulates the high priority frames, and sets the low priority frames to be transferred without division in a case where the high priority frames are not input and the accumulation unit does not accumulate the high priority frames.

### TECHNICAL FIELD

The present invention relates to a signal processing device, a signal processing method, a signal processing program, and a satellite communication system.

### BACKGROUND ART

A satellite communication system using a communication satellite is known as a system that enables data communication with a telephone service via a data-system network using a voice over IP (VoIP) technology.

For example, Non Patent Literature 1 discloses a data fragmentation function for dividing a data packet on a transmission side in VoIP, a voice priority control function, a technique for improving voice quality using a delay fluctuation absorption buffer, and the like.

### CITATION LIST

### Non Patent Literature

Non Patent Literature 1: Masaaki Takano, “Quality Evaluation of Internet Telephone,” Operations Research Society of Japan, March 2001, p.129(17)-134((22)

### SUMMARY OF INVENTION

### Technical Problem

However, in the conventional voice priority control, for example, in a case where a line speed is low as in a case where data communication with an IP telephone is performed via a communication satellite, processing may be delayed.

For example, even when a VoIP frame that is a high priority frame is input during output processing of a data communication frame that is a low priority frame, the VoIP frame is not output until output of the data communication frame that is currently being processed is completed. In addition, the delay amount of the VoIP frame varies depending on a timing at which the data arrives. Therefore, delay fluctuation also occurs.

The present invention has been made in view of the above-described problems, and an object thereof is to provide a signal processing device, a signal processing method, a signal processing program, and a satellite communication system capable of suppressing decrease in communication efficiency without increasing a delay amount and a delay fluctuation amount of a high priority frame.

### Solution to Problem

A signal processing device according to an embodiment of the present invention includes a distribution unit that distributes input high priority frames and low priority frames according to priorities, a transfer unit that processes and transfers each of the high priority frame and the low priority frame distributed by the distribution unit, an accumulation unit that accumulates each of the high priority frame and the low priority frame transferred by the transfer unit, a reading unit that sequentially reads out and outputs each of the high priority frame and the low priority frame accumulated by the accumulation unit according to priority, and a setting unit that sets the transfer unit to divide a low priority frame by a predetermined size and transfer the low priority frame in a case where a high priority frame is input to the distribution unit or in a case where the accumulation unit accumulates a high priority frame, and sets the transfer unit to transfer a low priority frame without dividing the low priority frame in a case where a high priority frame is not input to the distribution unit and the accumulation unit does not accumulate a high priority frame.

In addition, a signal processing method according to an embodiment of the present invention includes a distribution step of distributing input high priority frames and low priority frames according to priorities, a transfer step of processing and transferring each of the distributed high priority frame and low priority frame, an accumulation step in which an accumulation unit accumulates the transferred high priority frame and low priority frame, a reading step of sequentially reading out and outputting each of the high priority frame and the low priority frame accumulated by the accumulation unit according to priority, and a setting step of setting the low priority frame to be divided by a predetermined size and transferred in a case where the high priority frame is input or in a case where the accumulation unit accumulates the high priority frame, and setting the low priority frame to be transferred without being divided in a case where the high priority frame is not input and the accumulation unit does not accumulate the high priority frame.

A satellite communication system according to an embodiment of the present invention is a satellite communication system including a signal processing device that outputs high priority frames and low priority frames to an earth station that communicates via a communication satellite, in which the signal processing device includes a distribution unit that distributes input high priority frames and low priority frames according to priorities, a transfer unit that processes and transfers each of the high priority frame and the low priority frame distributed by the distribution unit, an accumulation unit that accumulates each of the high priority frame and the low priority frame transferred by the transfer unit, a reading unit that sequentially reads out and outputs each of the high priority frame and the low priority frame accumulated by the accumulation unit according to priority, and a setting unit that sets the transfer unit to divide a low priority frame by a predetermined size and transfer the low priority frame in a case where a high priority frame is input to the distribution unit or in a case where the accumulation unit accumulates a high priority frame, and sets the transfer unit to transfer a low priority frame without dividing the low priority frame in a case where a high priority frame is not input to the distribution unit and the accumulation unit does not accumulate a high priority frame.

### Advantageous Effects of Invention

According to the present invention, it is possible to suppress a decrease in communication efficiency without increasing a delay amount and a delay fluctuation amount of a high priority frame.

### BRIEF DESCRIPTION OF DRAWINGS

FIG. 1 is a diagram illustrating a configuration example of a satellite communication system according to an embodiment.

FIG. 2 is a block diagram illustrating functions of a signal processing device according to the embodiment and a vicinity of the signal processing device.

FIG. 3 is a flowchart illustrating an operation example of the signal processing device in a case where a low priority frame is input.

FIG. 4 is a flowchart illustrating an operation example of the signal processing device in a case where a high priority frame is input.

FIG. 5 is a block diagram illustrating functions of a modification example of the signal processing device and a vicinity of the modification example of the signal processing device.

FIG. 6 is a diagram illustrating a SIP message confirmed between a VoIP telephone terminal and a VoIP telephone terminal by a SIP confirmation unit.

FIG. 7 is a flowchart illustrating an operation example of a modification example of the signal processing device in a case where a low priority frame is input.

FIG. 8 is a flowchart illustrating an operation example of a modification example of the signal processing device in a case where a high priority frame is input.

FIG. 9 is a diagram illustrating a hardware configuration example of the signal processing device according to the embodiment.

FIG. 10 is a diagram schematically illustrating transmission processing of a VoIP frame and a data communication frame in a satellite communication system of a comparative example.

FIG. 11 is a diagram schematically illustrating transmission processing of VoIP frames and data communication frames by fragmentation in a satellite communication system of the comparative example.

FIG. 12 is a diagram illustrating a decrease in frame efficiency due to fragmentation.

### DESCRIPTION OF EMBODIMENTS

Before describing a satellite communication system according to an embodiment, first, the background of the present invention will be specifically described.

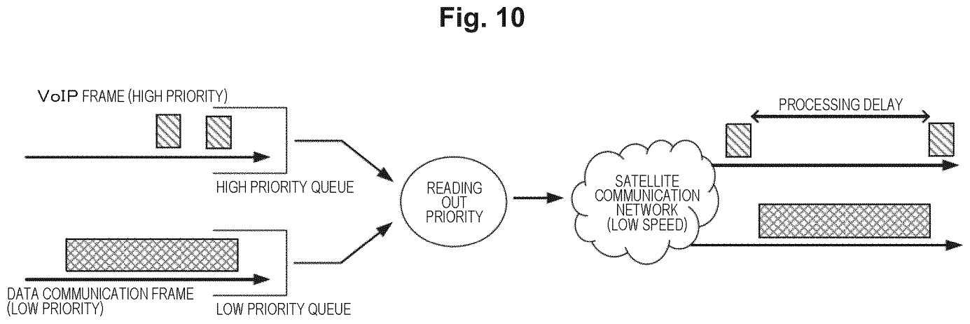

FIG. 10 is a diagram schematically illustrating transmission processing of a VoIP frame (voice communication) and a data communication frame (data communication) in a satellite communication system of a comparative example. It is assumed that each frame is an Ether frame of Ethernet (registered trademark).

Since quality in IP telephones is affected by delay and delay fluctuations, it is common to perform priority control. In the priority control, a VoIP frame (call data frame) that is a high priority frame is processed preferentially over a data communication frame, which is a low priority frame.

For example, in a case where the VoIP frame does not exist in the high priority queue, when a data communication frame is input to the low priority queue, the data communication frame is first output processed.

However, even if the high priority frame is input during the output processing of the low priority frame, the high priority frame is not output until the output of the low priority frame currently being processed is completed. That is, in the satellite communication system of the comparative example, even if priority control of giving priority to a VoIP frame is performed, processing for the VoIP frame may be delayed.

Furthermore, in the VoIP frame, since the delay amount varies depending on the timing of data arrival, delay fluctuation also occurs. The delay and delay fluctuation increase as the frame length increases, and increase as the communication speed decreases.

In addition, in a system with a low line speed such as a satellite communication system, a time for transmitting a frame becomes long. For example, in a case where the line speed is 64 kbps, about 190 ms are required to transmit a 1518 byte frame.

Therefore, in the VoIP frame, a processing delay of a maximum of 190 ms occurs even with a high priority, and delay fluctuation is also a maximum of 190 ms. The delay amount and the delay fluctuation deteriorate the quality of the IP telephone that normally transmits frames at regular intervals of 20 ms.

Therefore, for the VoIP frame, it is important to reduce the influence of the processing delay in order to suppress the delay amount and the delay fluctuation even in an environment where priority control is performed. As a method for reducing the processing delay, for example, there is a method called fragmentation in which a signal processing device divides an input VoIP frame into appropriate frame lengths and transmits the divided VoIP frame.

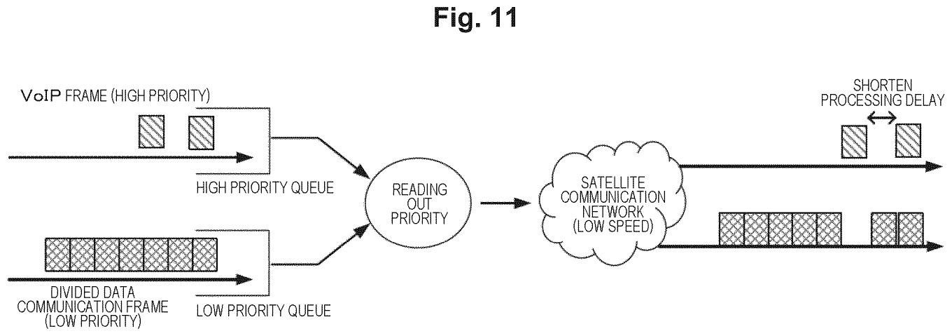

FIG. 11 is a diagram schematically illustrating transmission processing of VoIP frames and data communication frames by fragmentation in a satellite communication system of the comparative example.

The low priority data communication frame is divided by the fragmentation. Since the VoIP frame can be interrupted between the divided data communication frames, a delay amount and a delay fluctuation amount are suppressed. The fragmentation division size is fixedly set by a maximum transmission unit (MTU), a maximum segment size (MSS), or the like.

However, in a case where fragmentation is performed, it is possible to reduce the delay amount and the delay fluctuation amount of the high priority frame, but it is necessary to add a header to each piece of divided data.

Therefore, in data communication that usually uses a large amount of data having a maximum frame length of 1518 bytes, when fragmentation is performed, a proportion of headers increases, frame efficiency (data length/frame length) of data excluding the headers decreases, and a real communication speed also decreases.

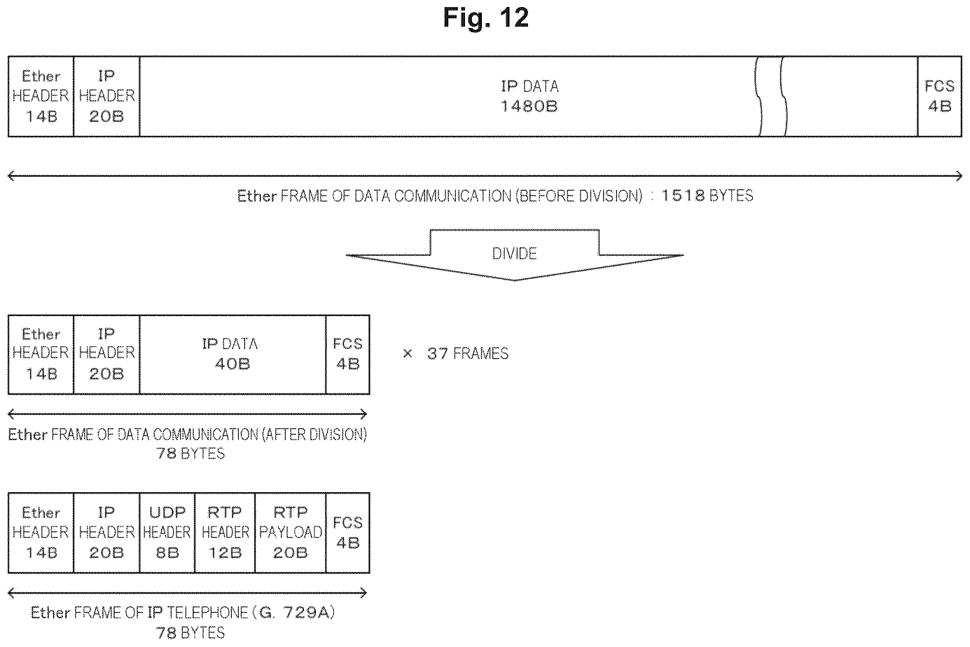

FIG. 12 is a diagram illustrating a decrease in frame efficiency due to fragmentation. For example, the frame length (78 bytes) of the VoIP frame encoded with G.729a and the frame length of the data communication frame are the same. In this case, the frame efficiency before fragmentation is about 97.5%, whereas the frame efficiency after fragmentation is about 51.3%. That is, the frame efficiency is greatly reduced to about half.

Fragmentation is necessary to reduce a delay amount and a delay fluctuation amount of the IP telephone using the VoIP technology. However, the IP telephone is not always communicating. Therefore, in the IP telephone, communication efficiency (frame efficiency) is greatly reduced due to fragmentation in an unused time period.

Therefore, a satellite communication system according to an embodiment to be described next is configured to be able to suppress a decrease in communication efficiency without increasing a delay amount and a delay fluctuation amount of a high priority frame even when a communication satellite network using a communication satellite is shared by a high priority frame such as an IP telephone and a low priority frame such as data communication.

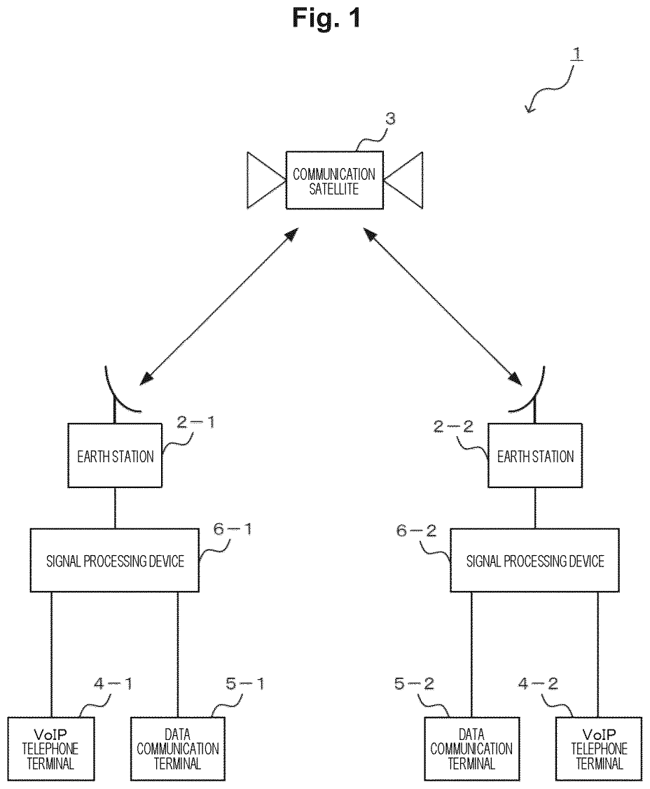

FIG. 1 is a diagram illustrating a configuration example of a satellite communication system 1 according to an embodiment. As illustrated in FIG. 1, the satellite communication system 1 is configured such that, for example, earth stations 2-1 and 2-2 communicate with each other via a communication satellite 3.

In the earth station 2-1, for example, a VoIP telephone terminal 4-1 and a data communication terminal 5-1 are connected via a signal processing device 6-1. For example, the signal processing device 6-1 performs predetermined processing on a VoIP frame that is a high priority frame output from the VoIP telephone terminal 4-1, and outputs the processed frame to the earth station 2-1. In addition, the signal processing device 6-1 performs predetermined processing on, for example, a data communication frame that is a low priority frame output by the data communication terminal 5-1, and outputs the data communication frame to the earth station 2-1.

In the earth station 2-2, for example, a VoIP telephone terminal 4-2 and a data communication terminal 5-2 are connected via a signal processing device 6-2. For example, the signal processing device 6-2 performs predetermined processing on a VoIP frame that is a high priority frame output from the VoIP telephone terminal 4-2 and outputs the processed frame to the earth station 2-2 In addition, the signal processing device 6-2 performs predetermined processing on, for example, a data communication frame that is a low priority frame output by the data communication terminal 5-2, and outputs the data communication frame to the earth station 2-2.

Then, the VoIP telephone terminal 4-1 makes a call by IP telephone with the VoIP telephone terminal 4-2 via the communication satellite 3. In addition, the data communication terminal 5-1 performs data communication with the data communication terminal 5-2 via the communication satellite 3.

Hereinafter, in a case where any of a plurality of configurations such as the signal processing devices 6-1 and 6-2 is not specified, it is simply abbreviated as the signal processing device 6 or the like.

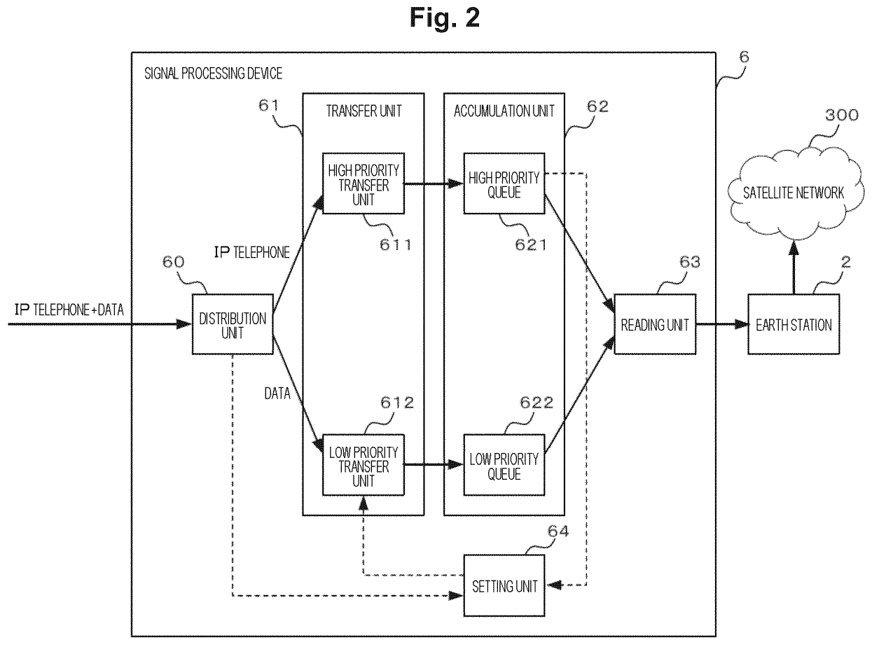

FIG. 2 is a block diagram illustrating functions of the signal processing device 6 according to the embodiment and a vicinity of the signal processing device 6. As illustrated in FIG. 2, the signal processing device 6 includes, for example, a distribution unit 60, a transfer unit 61, an accumulation unit 62, a reading unit 63, and a setting unit 64. Note that a satellite network 300 is a network including the communication satellite 3 illustrated in FIG. 1 and the like.

The distribution unit 60 distributes the input high priority frame (IP telephone) and low priority frame (data) according to the priority, and outputs the frames to the transfer unit 61. Furthermore, in a case where a high priority frame is input, the distribution unit 60 has a function of notifying the setting unit 64 of the input.

The transfer unit 61 includes a high priority transfer unit 611 and a low priority transfer unit 612, processes the high priority frame and the low priority frame distributed by the distribution unit 60, and transfers the frames to the accumulation unit 62.

Note that the high priority transfer unit 611 performs processing on the high priority frame output by the distribution unit 60 and transfers the frame to the accumulation unit 62. The low priority transfer unit 612 performs processing on the low priority frame output by the distribution unit 60 and transfers the frame to the accumulation unit 62. For example, the low priority transfer unit 612 divides the low priority frame on the basis of division size setting information to be described later, and transfers the divided low priority frame to the accumulation unit 62.

The accumulation unit 62 includes a high priority queue 621 and a low priority queue 622, and accumulates each of the high priority frame and the low priority frame transferred by the transfer unit 61. Note that the high priority queue 621 accumulates the high priority frames transferred by the high priority transfer unit 611. Furthermore, in a case where high priority frames are accumulated, the high priority queue 621 has a function of notifying the setting unit 64 of the number of accumulated high priority frames, for example. Furthermore, the low priority queue 622 accumulates the low priority frames transferred by the low priority transfer unit 612.

The reading unit 63 sequentially reads the high priority frames accumulated in the high priority queue 621 and the low priority frames accumulated in the low priority queue 622 in accordance with the priorities, and outputs the frames to the earth station 2.

In a case where the distribution unit 60 is notified that the high priority frame has been input or in a case where the high priority queue 621 is notified that the high priority frame has been accumulated, the setting unit 64 performs setting such that the low priority transfer unit 612 divides the low priority frame by a predetermined size and transfers the divided frames. For example, the setting unit 64 outputs, to the low priority transfer unit 612, division size setting information for setting a division size according to the number of high priority frames notified from the high priority queue 621, and sets a division size for a low priority frame to the low priority transfer unit 612.

Furthermore, in a case where the high priority frame is not input to the distribution unit 60 and the high priority queue 621 does not accumulate the high priority frame, the setting unit 64 performs setting so that the low priority transfer unit 612 transfers the low priority frame without dividing the low priority frame (or by dividing the low priority frame by a predetermined division size).

That is, the signal processing device 6 performs fragmentation according to the setting performed by the setting unit 64. In the example described above, the signal processing device 6 is configured such that the setting unit 64 performs setting for the low priority transfer unit 612 based on the notification from the distribution unit 60 and the notification from the high priority queue 621, but the present invention is not limited thereto. For example, the signal processing device 6 may include a determination unit that performs determination based on a notification from the distribution unit 60 and the high priority queue 621, and the setting unit 64 may perform similar setting for the low priority transfer unit 612 according to a determination result of the determination unit.

In addition, in FIG. 2, the signal processing device 6 has a function of transmitting a frame, but the signal processing device 6 may have a function of performing defragmentation when receiving a frame.

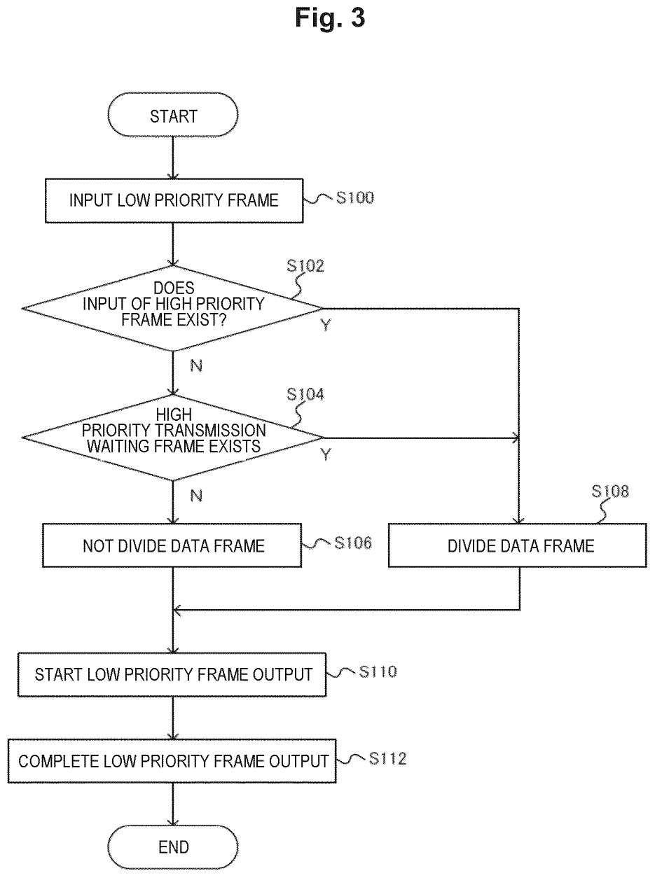

Next, an operation example of the signal processing device 6 will be described. FIG. 3 is a flowchart illustrating an operation example of the signal processing device 6 in a case where a low priority frame is input.

As illustrated in FIG. 3, when a low priority frame is input (S100), the signal processing device 6 determines whether an input of a high priority frame exists(S102). In a case of determining that the input of the high priority frame does not exist (S102: No), the signal processing device 6 proceeds to the processing of S104, and in a case of determining that the input of the high priority frame exists (S102: Yes), the signal processing device 6 proceeds to the processing of S108.

Next, the signal processing device 6 determines whether a high priority transmission waiting frame exists(S104). In a case of determining that the high priority transmission waiting frame does not exist (S104: No), the signal processing device 6 proceeds to the processing of S106. In a case of determining that the high priority transmission waiting frame exists (S104: Yes), the signal processing device 6 proceeds to the processing of S108.

In step 106 (S106), the signal processing device 6 performs setting such that the setting unit 64 does not divide the data frame for the low priority transfer unit 612.

In step 108 (S108), the signal processing device 6 performs setting such that the setting unit 64 divides the data frame for the low priority transfer unit 612.

In step 110 (S110), in the signal processing device 6, the reading unit 63 reads out the low priority frame from the low priority queue 622 and starts outputting.

In step 112 (S112), in the signal processing device 6, the reading unit 63 finishes reading the low priority frame from the low priority queue 622 and completes the output. Note that, in a case where the low priority frame that is not divided is transmitted, the signal processing device 6 requires 190 ms at the maximum, for example.

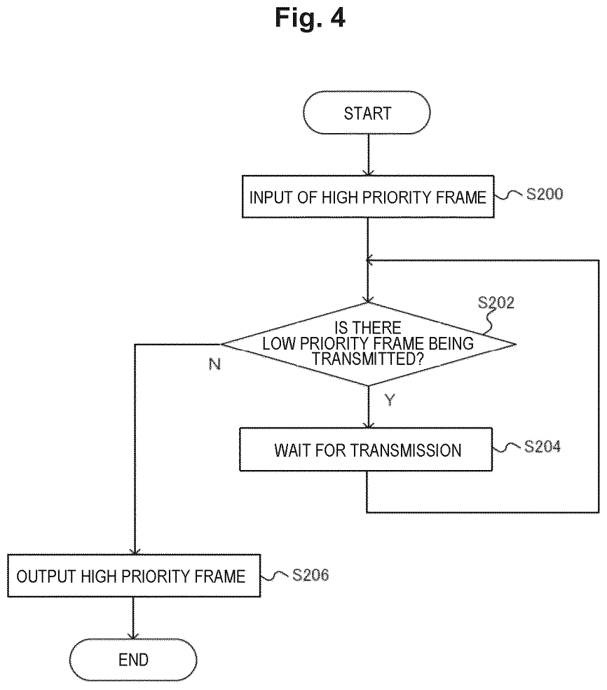

FIG. 4 is a flowchart illustrating an operation example of the signal processing device 6 in a case where a high priority frame is input.

As illustrated in FIG. 4, when a high priority frame is input (S200), the signal processing device 6 determines whether there is a low priority frame being transmitted (S202). In a case of determining that there is a low priority frame being transmitted (S202: Yes), the signal processing device 6 proceeds to the processing of S204, and in a case of determining that there is no low priority frame being transmitted (S202: No), the signal processing device 6 proceeds to the processing of S206. The high priority frame is a call data frame of the IP telephone, and is input in a cycle of 20 ms.

In step 204 (S204), the signal processing device 6 waits for transmission of the high priority frame, and returns to the processing of S202.

In step 206 (S206), in the signal processing device 6, the reading unit 63 reads out the high priority frame from the high priority queue 621 and outputs the frame.

As described above, in the signal processing device 6 according to the embodiment, in a case where the high priority frame is input to the distribution unit 60 or in a case where the accumulation unit 62 accumulates the high priority frame, the transfer unit 61 sets the low priority frame to be divided by the predetermined size and transferred, and in a case where the high priority frame is not input to the distribution unit 60 and the accumulation unit 62 does not accumulate the high priority frame, the transfer unit 61 sets the low priority frame to be transferred without being divided. Therefore, it is possible to suppress a decrease in communication efficiency without increasing the delay amount and the delay fluctuation amount of the high priority frame.

Note that, in the signal processing device 6, a high priority frame may be input when a low priority frame is input at the beginning of a call by the VoIP telephone terminal 4 (see FIG. 1). In this case, since the low priority frame is not divided, delay fluctuation may occur.

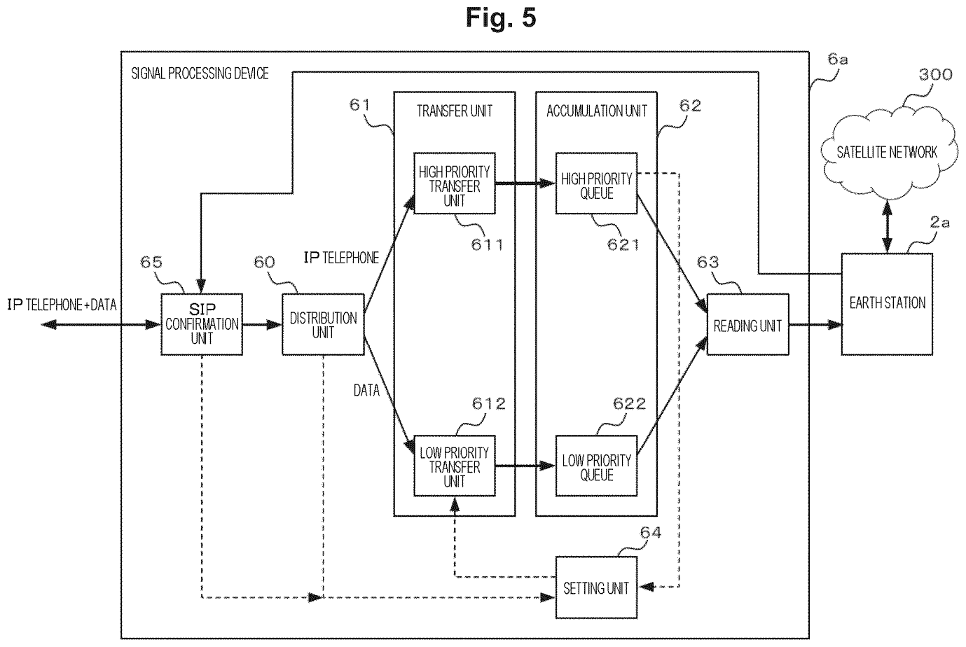

Next, a modification example of the signal processing device 6 will be described. FIG. 5 is a block diagram illustrating functions of a modification example (signal processing device 6a) of the signal processing device 6 and a vicinity of the modification example of the signal processing device.

As illustrated in FIG. 5, the signal processing device 6a includes, for example, the distribution unit 60, the transfer unit 61, the accumulation unit 62, the reading unit 63, the setting unit 64, and a session initiation protocol (SIP) confirmation unit 65. Note that an earth station 2a has a function of mediating a SIP message. Furthermore, in the signal processing device 6a illustrated in FIG. 5, substantially the same components as those of the signal processing device 6 illustrated in FIG. 2 are denoted by the same reference numerals.

The SIP confirmation unit 65 has a function of confirming the content of the SIP message, and outputs a high priority frame (IP telephone) and a low priority frame (data) input to the signal processing device 6a to the distribution unit 60. Further, the SIP confirmation unit 65 may have a function as a SIP server that confirms the message type and the user address information.

For example, in a case where the SIP confirmation unit 65 confirms establishment of a session for the high priority frame input to the signal processing device 6a or confirms an end of a session for the high priority frame, the SIP confirmation unit outputs a notification indicating the fact to the setting unit 64.

Furthermore, in the signal processing device 6a, the setting unit 64 has a function of performing setting such that the low priority transfer unit 612 divides the low priority frame by the predetermined size and transfers the divided low priority frame when a notification indicating that establishment of a session for the high priority frame has been confirmed is input from the SIP confirmation unit 65.

Furthermore, in the signal processing device 6a, the setting unit 64 has a function of performing setting so that the low priority transfer unit 612 transfers the low priority frame without dividing the low priority frame (or dividing the low priority frame by the predetermined division size) in a case where a notification indicating that the end of the session for the high priority frame has been confirmed is input from the SIP confirmation unit 65 and the high priority queue 621 has not accumulated the high priority frame.

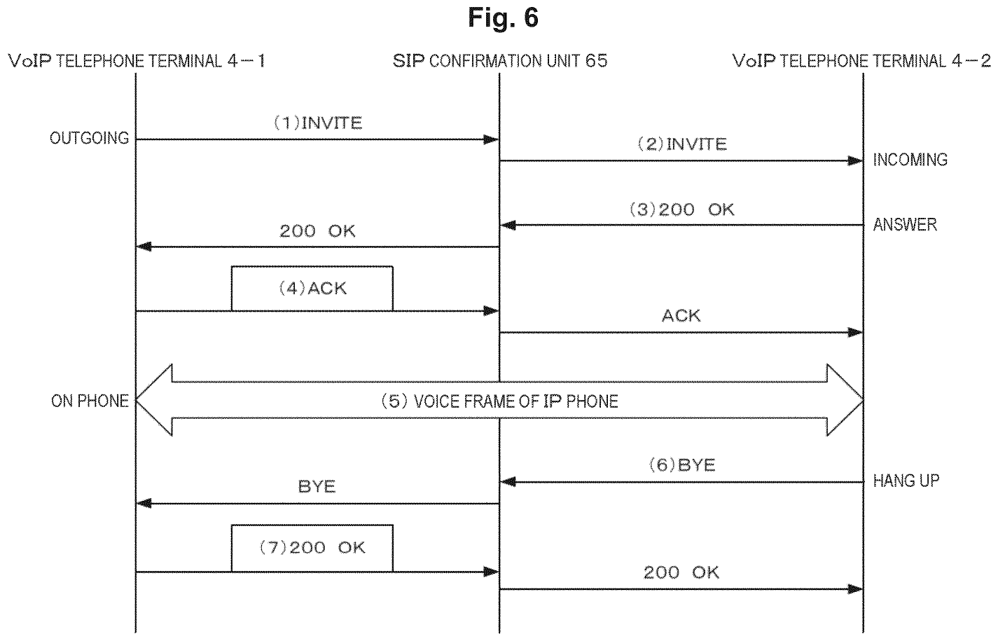

FIG. 6 is a diagram illustrating a SIP message confirmed between the VoIP telephone terminal 4-1 and the VoIP telephone terminal 4-2 by the SIP confirmation unit 65.

When the SIP confirmation unit 65 confirms reception of an ACK response (acceptance of establishment of a session) subsequent to the INVITE message, a call state using the voice frame of the IP telephone is established, and the signal processing device 6a divides and outputs the low priority frame.

Furthermore, in a case where the SIP confirmation unit 65 confirms reception of 200 OK (success) subsequent to BYE (session disconnection request), and the high priority transmission waiting frame does not exist (in a case where the call is ended and there is no high priority frame), the signal processing device 6a transmits the low priority frame without division.

Note that, in a case where communication satellite 3 (see FIG. 1) is a geostationary earth orbiting satellite, transmission and reception of SIP messages are delayed by 250 ms or more in a satellite section. That is, the signal processing device 6a has a delay (time lag) of 250 ms or more from the reception of the SIP message to the start of frame transmission of the IP telephone.

Therefore, in a case where the line speed of satellite communication in the satellite communication system 1 is, for example, 64 kbps, about 190 ms is required as the transmission time for transmitting a 1518 byte frame, but the transmission time is shorter than the delay (250 ms) in the satellite section. Therefore, the signal processing device 6a can change the division size of the low priority frame before sending the first high priority frame (IP telephone voice frame).

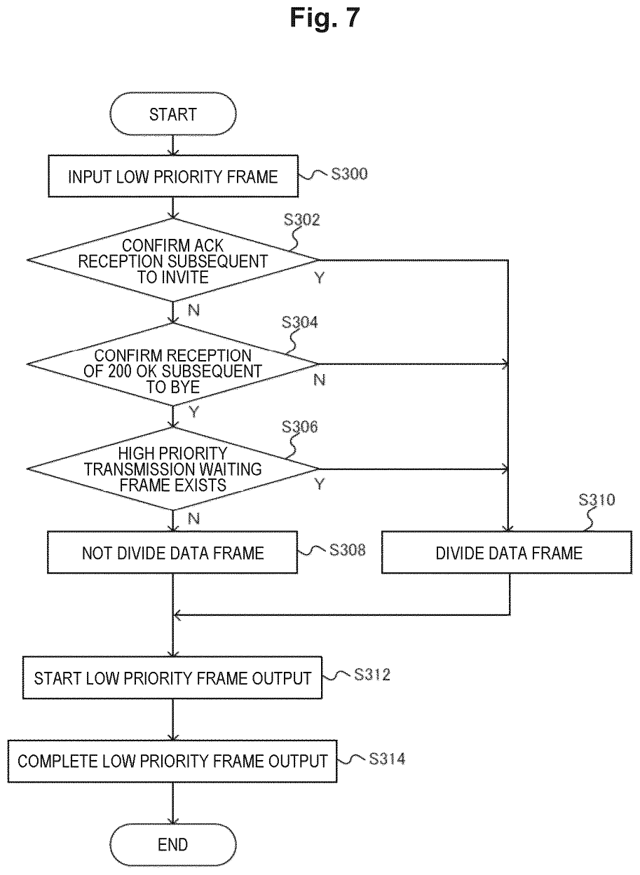

Next, an operation example of the signal processing device 6a will be described. FIG. 7 is a flowchart illustrating an operation example of the signal processing device 6a in a case where a low priority frame is input.

As illustrated in FIG. 7, when the low priority frame is input (S300), the signal processing device 6a determines whether ACK reception is confirmed subsequent to INVITE (S302). In a case where it is determined that the reception of the ACK subsequent to INVITE has not been confirmed (S302: No), the signal processing device 6a proceeds to the processing of S304. When it is determined that the reception of the ACK subsequent to INVITE has been confirmed (S302: Yes), the signal processing device 6a proceeds to the processing of S310.

Furthermore, the signal processing device 6a determines whether reception of 200 OK has been confirmed subsequent to BYE (S304). The signal processing device 6a proceeds to the processing of S306 in a case of determining that the reception of 200 OK has been confirmed following BYE (S304: Yes), and proceeds to the processing of S310 in a case of determining that the reception of 200 OK has not been confirmed following BYE (S304: No).

In addition, the signal processing device 6a determines whether the high priority transmission waiting frame exists (S306). When the signal processing device 6a determines that the high priority transmission waiting frame does not exist (S306: No), the signal processing device 6a proceeds to the processing in S308, and in a case where the signal processing device 6a determines that the high priority transmission waiting frame exists (S306: Yes), the signal processing device 6a proceeds to the processing in S310.

In step 308 (S308), the signal processing device 6a performs setting such that the setting unit 64 (see FIG. 5) does not divide the data frame for the low priority transfer unit 612.

In step 310 (S310), the signal processing device 6a performs setting such that the setting unit 64 divides the data frame for the low priority transfer unit 612.

In step 312 (S312), in the signal processing device 6a, the reading unit 63 reads out the low priority frame from the low priority queue 622 and starts outputting.

In step 314 (S314), in the signal processing device 6a, the reading unit 63 finishes reading the low priority frame from the low priority queue 622 and completes the output. Note that, in a case where the low priority frame that is not divided is transmitted, the signal processing device 6a requires 190 ms at the maximum, for example.

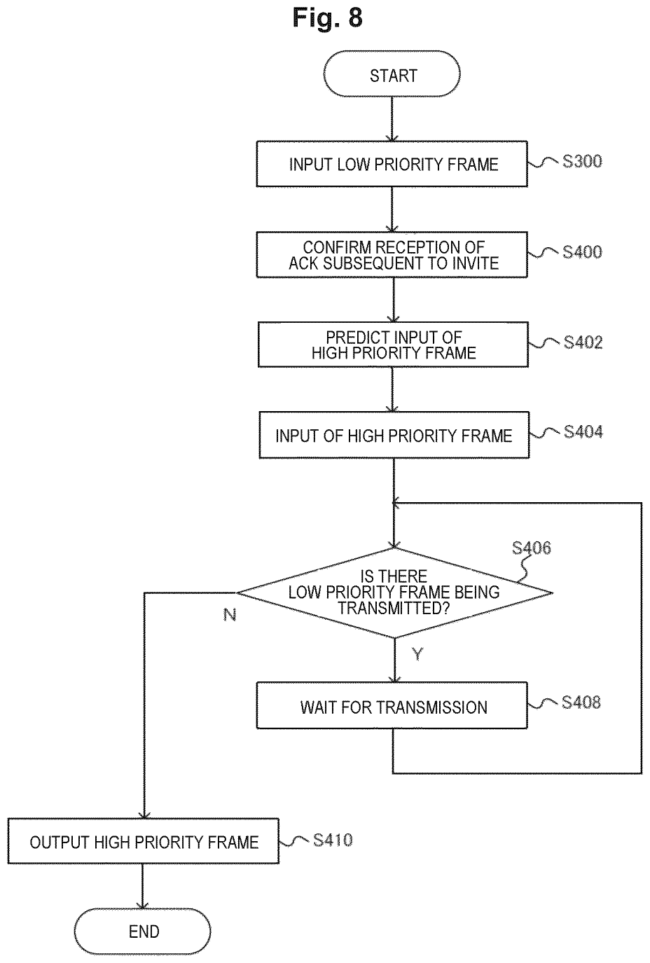

FIG. 8 is a flowchart illustrating an operation example of the signal processing device 6a in a case where a high priority frame is input.

As illustrated in FIG. 8, when the high priority frame is input (S300) and the reception of the ACK is confirmed subsequent to the INVITE (S400), the signal processing device 6a predicts that the high priority frame is input (S402).

Then, when the high priority frame is input (S404), the signal processing device 6a determines whether there is a low priority frame being transmitted (S406). In a case of determining that there is a low priority frame being transmitted (S406: Yes), the signal processing device 6a proceeds to the processing of S408, and in a case of determining that there is no low priority frame being transmitted (S406: No), the signal processing device 6 proceeds to the processing of S410. The high priority frame is a call data frame of the IP telephone, and is input in a cycle of 20 ms.

In step 408 (S408), the signal processing device 6a waits for transmission of the high priority frame, and returns to the processing of S406.

In step 410 (S410), in the signal processing device 6a, the reading unit 63 reads out the high priority frame from the high priority queue 621 and outputs the frame.

As described above, in the signal processing device 6a according to the embodiment, in a case where the SIP confirmation unit 65 confirms the establishment of the session for the high priority frame, the transfer unit 61 sets to divide the low priority frame by the predetermined size and transfer the divided low priority frame, and in a case where the SIP confirmation unit 65 confirms the end of the session for the high priority frame and the accumulation unit 62 does not accumulate the high priority frame, the transfer unit 61 sets to transfer the low priority frame without dividing the low priority frame.

Therefore, it is possible to suppress a decrease in communication efficiency without increasing the delay amount and the delay fluctuation amount of the high priority frame.

In addition, since the signal processing device 6 described above does not predict that the IP telephone frame is input, there is a possibility that the low priority frame cannot be divided in a case where the high priority frame is input when the first low priority frame is input. However, the signal processing device 6 does not need a function for confirming the SIP message.

On the other hand, since the signal processing device 6a described above can predict that the IP telephone frame is input before 250 ms or more by the SIP message, the data communication frame can be optimally divided before the IP telephone frame arrives. However, the signal processing device 6a needs to have a function for confirming transmission and reception of SIP messages.

Note that some or all of the functions of the signal processing device 6 and the signal processing device 6a may be configured by hardware such as a programmable logic device (PLD) or a field programmable gate array (FPGA), or may be configured as a program executed by a processor such as a CPU.

For example, the signal processing device 6 and the signal processing device 6a according to an embodiment can be implemented by using a computer and a program, and the program can be recorded on a storage medium or provided via a network.

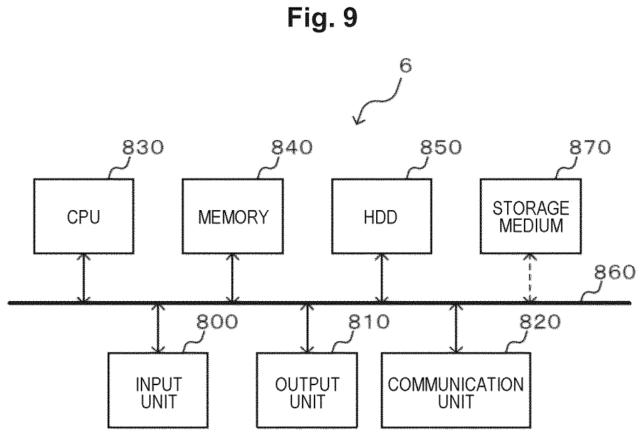

FIG. 9 is a diagram illustrating a hardware configuration example of the signal processing device 6 (or the signal processing device 6a) according to the embodiment. As illustrated in FIG. 9, for example, the signal processing device 6 has a function as a computer in which an input unit 800, an output unit 810, a communication unit 820, a CPU 830, a memory 840, and an HDD 850 are connected via a bus 860. The signal processing device 6 can input and output data to and from a computer-readable storage medium 870.

The input unit 800 is, for example, a keyboard, a mouse, or the like. The output unit 810 is, for example, a display device such as a display. The communication unit 820 is, for example, a network interface or the like.

The CPU 830 controls each unit included in the signal processing device 6 and performs a predetermined process and the like. The memory 840 and the HDD 850 are storage units that store data and the like.

The storage medium 870 can store a program or the like that executes the functions of the signal processing device 6. An architecture of the signal processing device 6 is not limited to the example illustrated in FIG. 9.

### REFERENCE SIGNS LIST

1 Satellite communication system
2, 2-1, 2-2, 2a Earth station
3 Communication satellite
4-1, 4-2 VoIP telephone terminal
5-1, 5-2 Data communication terminal
6, 6-1, 6-2, 6a Signal processing device
60 Distribution unit
61 Transfer unit
62 Accumulation unit
63 Reading unit
64 Setting unit
65 SIP confirmation unit
300 Satellite network
611 High priority transfer unit
612 Low priority transfer unit
621 High priority queue
622 Low priority queue
800 Input unit
810 Output unit
820 Communication unit
830 CPU
840 Memory
850 HDD
860 Bus
870 Storage medium

1. A signal processing device comprising:
distribution circuitry that distributes input high priority frames and low priority frames according to priorities;
transfer circuitry that processes and transfers each of the high priority frame and the low priority frame distributed by the distribution circuitry;
accumulation circuitry that accumulates each of the high priority frame and the low priority frame transferred by the transfer circuitry;
reading circuitry that sequentially reads out and outputs each of the high priority frame and the low priority frame accumulated by the accumulation circuitry according to priority; and
setting circuitry that sets the transfer circuitry to divide a low priority frame by a predetermined size and transfer the low priority frame in a case where a high priority frame is input to the distribution circuitry or in a case where the accumulation circuitry accumulates a high priority frame, and sets the transfer circuitry to transfer a low priority frame without dividing the low priority frame in a case where a high priority frame is not input to the distribution circuitry and the accumulation circuitry does not accumulate a high priority frame.

2. The signal processing device according to claim 1, further comprising:
SIP confirmation circuitry that confirms a content of a SIP message,
wherein the setting circuitry sets the transfer circuitry to divide the low priority frame by a predetermined size and transfer the low priority frame, and the SIP confirmation circuitry confirms an end of a session for the high priority frame, in a case where the SIP confirmation circuitry confirms the establishment of the session for high priority frames, and the setting circuitry sets the transfer circuitry to transfer the low priority frame without dividing the low priority frame in a case where the accumulation circuitry does not accumulate high priority frames.

3. The signal processing device according to claim 1, wherein the high priority frame is a call data frame of an IP telephone.

4. A signal processing method comprising:
a distribution step of distributing input high priority frames and low priority frames according to priorities;
a transfer step of processing and transferring each of the distributed high priority frame and low priority frame;
an accumulation step in which an accumulation circuitry accumulates the transferred high priority frame and low priority frame;
a reading step of sequentially reading out and outputting each of the high priority frame and the low priority frame accumulated by the accumulation circuitry according to priority; and
a setting step of setting the low priority frame to be divided by a predetermined size and transferred in a case where the high priority frame is input or in a case where the accumulation circuitry accumulates the high priority frame, and setting the low priority frame to be transferred without being divided in a case where the high priority frame is not input and the accumulation circuitry does not accumulate the high priority frame.

5. The signal processing method according to claim 4, further comprising:
a SIP confirmation step of confirming content of a SIP message,
wherein in the setting step,
in a case where an establishment of a session with respect to the high priority frame is confirmed, setting is made such that the low priority frame is divided by a predetermined size and transferred, and in a case where an end of the session with respect to the high priority frame is confirmed, and when the accumulation circuitry does not accumulate the high priority frame, setting is made such that the low priority frame is transferred without being divided.

6. The signal processing method according to claim 4, wherein the high priority frame is a call data frame of an IP telephone.

7. A non-transitory computer readable medium storing a signal processing program for causing a computer to function as each circuitry of the signal processing device according to claim 1.

8. A satellite communication system comprising:
signal processing circuitry that outputs high priority frames and low priority frames to an earth station that communicates via a communication satellite, the signal processing circuitry including:
distribution circuitry that distributes input high priority frames and low priority frames according to priorities,
transfer circuitry that processes and transfers each of the high priority frame and the low priority frame distributed by the distribution circuitry,
accumulation circuitry that accumulates each of the high priority frame and the low priority frame transferred by the transfer circuitry,
reading circuitry that sequentially reads out and outputs each of the high priority frame and the low priority frame accumulated by the accumulation circuitry according to priority, and
setting circuitry that sets the transfer circuitry to divide a low priority frame by a predetermined size and transfer the low priority frame in a case where a high priority frame is input to the distribution circuitry or in a case where the accumulation circuitry accumulates a high priority frame, and sets the transfer circuitry to transfer a low priority frame without dividing the low priority frame in a case where a high priority frame is not input to the distribution circuitry and the accumulation circuitry does not accumulate a high priority frame.

9. A non-transitory computer readable medium storing a program for causing a computer to perform the signal processing method of claim 4.
